(19) United States
(12) Patent Application Publication
(10) Pub. No.: US 2011/0086237 A1
(43) Pub. Date: Apr. 14, 2011

(54) BONDING APPARATUS

(75) Inventors: David Ronald Alfred Chambers, Loughborough (GB); Nigel Andrew Finney, Loughborough (GB); Stuart Ward, Loughborough (GB); Matthew Richard Turner, Loughborough (GB)

(73) Assignee: EPL COMPOSITE SOLUTIONS LTD, Loughborough (GB)

(21) Appl. No.: 12/918,458

(22) PCT Filed: Feb. 19, 2009
(86) PCT No.: PCT/GB2009/000459

§ 371 Date: Dec. 21, 2010

(30) Foreign Application Priority Data
Feb. 20, 2008 (GB) 0803027.2

(51) Int. Cl. B32B 37/26; B32B 37/12; B32B 37/06; B32B 37/02; B32B 37/04; B32B 41/00; B32B 27/32

(52) U.S. Cl. 428/516; 156/499; 156/350; 156/359; 156/362; 156/322

(57) ABSTRACT

Bonding apparatus (10) for bonding a thermoplastic first material (12) to a second material (14) includes a heater arrangement (22) for heating a bonding surface (16) of the first material (12) to melt the bonding surface (16), and moving means (30) for moving the first and second materials (12, 14) together to a bonded condition.

The present invention relates to bonding apparatus, particularly, but not exclusively, for bonding a thermoplastic material to a second material, and a process for bonding materials, particularly, but not exclusively, for bonding a thermoplastic material to another material.

Conventionally, panels for building or for applications such as the lining of vans and trucks are formed of plywood. However, plywood is relatively expensive to manufacture and is seen as undesirable when produced from tropical hardwoods.

In this specification, a thermoplastic material is a material which has the property of softening and melting when heated and then of hardening and becoming rigid again when cooled. Such thermoplastic materials can be melted and cooled time after time without undergoing any appreciable chemical change.

According to a first aspect of the present invention, there is provided bonding apparatus for bonding a thermoplastic first material to a second material, the apparatus including a heater arrangement for heating a bonding surface of the first material to melt the bonding surface, and moving means for moving the first and second materials together to a bonded condition.

Possibly, the heater arrangement includes a first heater which is arranged to heat the bonding surface of the first material. Possibly, the first heater is arranged to heat the bonding surface of the first material to a temperature which is below the melting point of the first material.

Possibly the heater arrangement includes a second heater, which may be arranged to heat the bonding surface of the first material. Possibly the second heater heats the bonding surface of the first material to a temperature that is above the melting temperature of the first material.

Possibly, the second material includes a bonding surface, and in the bonded condition, the bonding surface of the first material is bonded to the bonding surface of the second material.

Possibly, the second material is a thermoplastic material. Possibly the heater arrangement includes a third, heater, which may be arranged to heat the second material bonding surface. Possibly the heater arrangement is arranged to melt the bonding surface, of the second material.

Possibly, the third heater is arranged to heat the bonding surface of the second material to a temperature which is below the melting point of the second material. Possibly the second heater heats the bonding surface of the second material, and may heat the bonding surface of the second material to a temperature that is above the melting temperature of the second material.

Possibly, the moving means move the first and second materials to a bonding position, in which the first material bonding surface and the second material bonding surface come into contact.

Possibly, the second heater is arranged to heat the bonding surface of the first material at or adjacent to the bonding position. Possibly, the second heater is arranged to heat the bonding surface of the second material at or adjacent to the bonding position.

Possibly, the apparatus is arranged so that at the bonding position, the temperature of the first material decreases through the material, and may be arranged so that at an opposite first material non-bonding surface the temperature of the first material is lower than the melting point of the first material.

Possibly, the apparatus is arranged so that at the bonding position, the temperature of the second material decreases at least initially from the second material bonding surface through the second material to a temperature which is lower than the melting point of the second material.

Possibly, the moving means include a pressure applicator, which may be arranged to force the first and second materials together to the bonded condition.

Possibly, the apparatus includes control means, which may include a temperature sensor, which may sense the temperature of the first material, and may sense the temperature of the first material in the bonded condition.

Possibly, the control means includes a controller. Possibly, the control means is arranged so that the sensor provides a signal to the controller. The controller may control the heat output of the heater arrangement in response to the signal. The controller may control the spacing of the or each heater from the or each respective bonding surface in response to the signal. The controller may control the speed of the movement of the moving means in response to the signal.

Possibly, the first material is relatively thin, and the second material is relatively thick. Possibly the first material is in the form of a skin and the second material may be in the form of a core. Possibly, in the bonded condition the first and second materials form a composite material, which may be shaped to form a planar, sheet-like panel.

Possibly the or each of the first and/or second material is a plastics material, which may melt at a temperature of 180-190° C., and may be polypropylene.

Possibly, the bonding apparatus includes another heater arrangement for heating a bonding surface of another first material to melt the bonding surface, and another moving means for moving the other first and the second materials together to a bonded condition, the other first material being bonded to an opposite side of the second material.

Possibly, the bonding apparatus includes a further heater arrangement for heating a bonding surface of a further first material to melt the bonding surface, and a further moving means for moving the further first and the second materials together to a bonded condition, the further first material being bonded to the first material or the other first material which is already bonded to the second material.

Possibly, the bonding apparatus includes a module, which may include the heater arrangement and the moving means or a pair of opposing heater arrangements and moving means. Possibly, in use, the module bonds a skin of the first material to the second material or a pair of opposing skins of the first material to the second material. The bonding apparatus may include a plurality of modules. Each successive module may bond a further skin or pair of skins of the first material to the second material.

Possibly the heater arrangement is arranged to heat a third material, which may be a thermoplastic material, and may be arranged to heat a bonding surface of the third material to melt the bonding surface. Possibly, the moving means are arranged to move the third material and the first and/or second materials together to a bonded condition. Possibly in the bonded condition the third material is bonded to an edge of the bonded first and second materials.

According to a second aspect of the present invention, there is provided a process for bonding a thermoplastic first material to a second material, the process including the steps of applying heat to a surface of the first material to melt the surface and moving the first material and the second material together to a bonded condition.

Possibly, the process includes the step of providing bonding apparatus for bonding the first thermoplastic material to the second material. Possibly the bonding apparatus is as described above in any of the preceding paragraphs.

According to a third aspect of the present invention, there is provided a bonded product, the bonded product comprising a thermoplastic first material bonded to a second material, the product produced by bonding apparatus as described in any of the previous paragraphs.

Embodiments of the present invention will now be described, by way of example only, and with reference to the accompanying drawings, in which:—

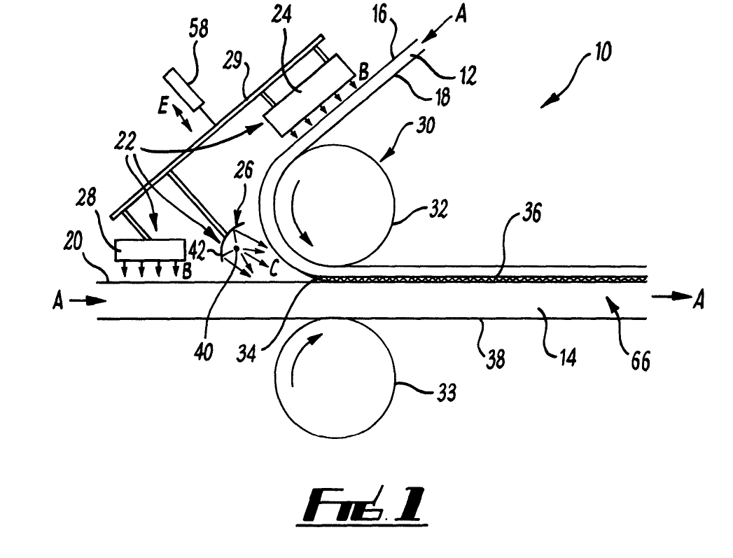

FIG. 1 is a simplified schematic view of bonding apparatus for bonding materials;

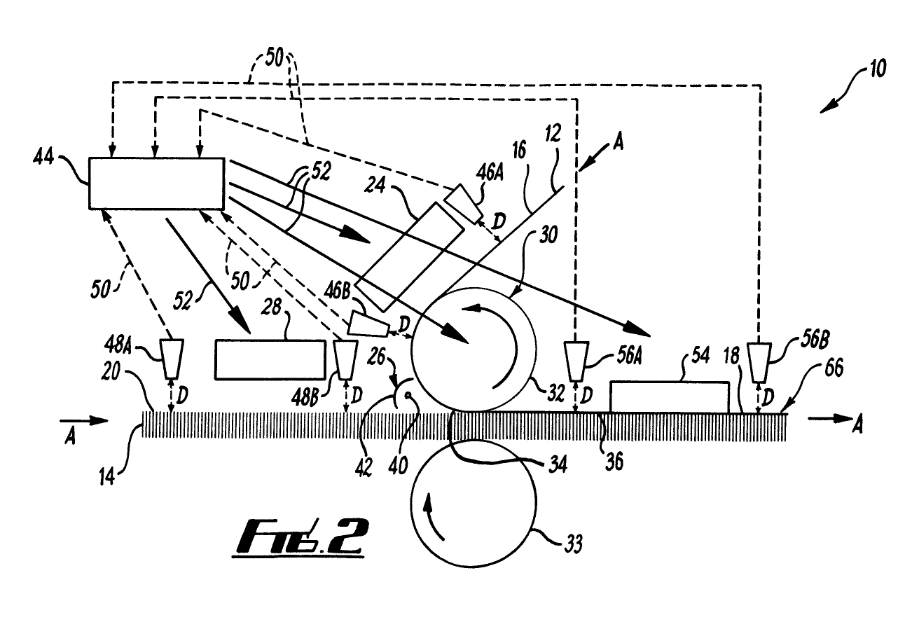

FIG. 2 is a schematic view of the apparatus of FIG. 1 in more detail;

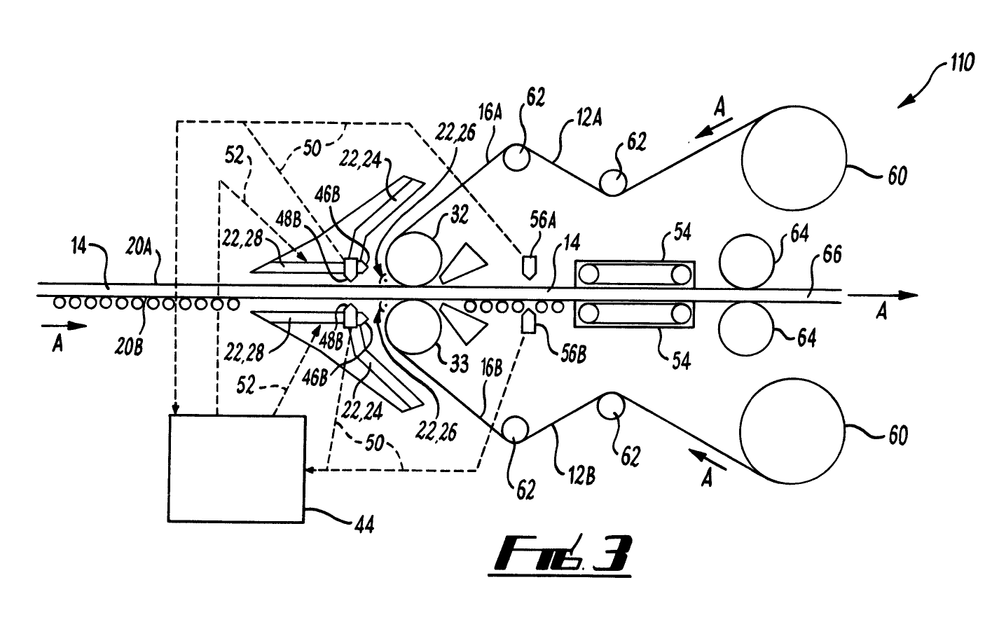

FIG. 3 is a schematic view of another apparatus for bonding materials;

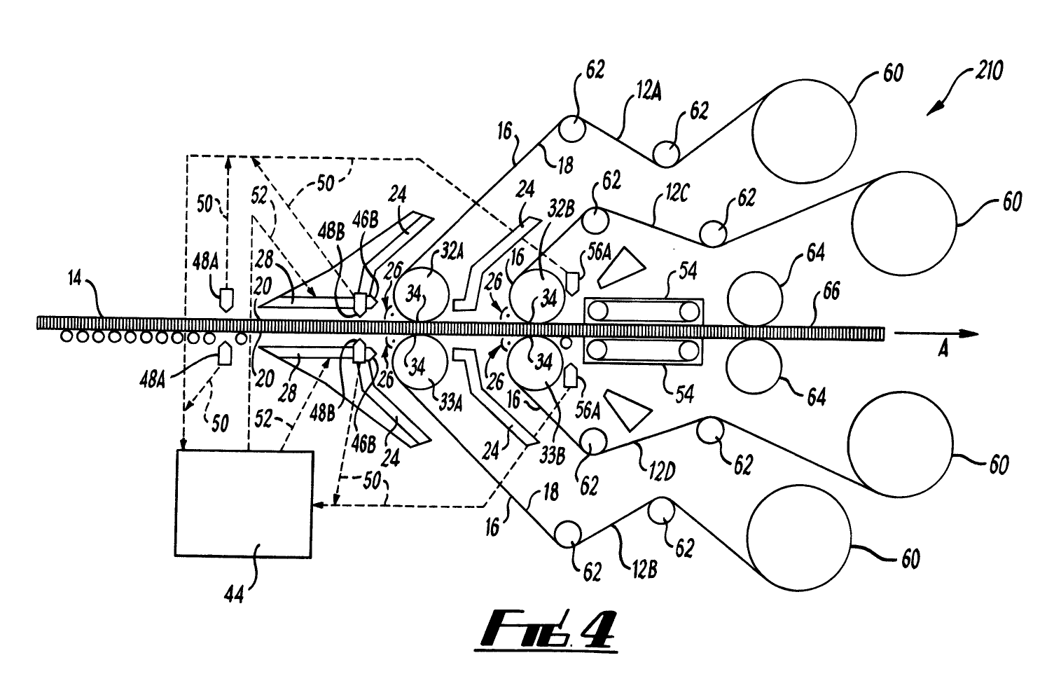

FIG. 4 is a schematic view of a third apparatus for bonding materials;

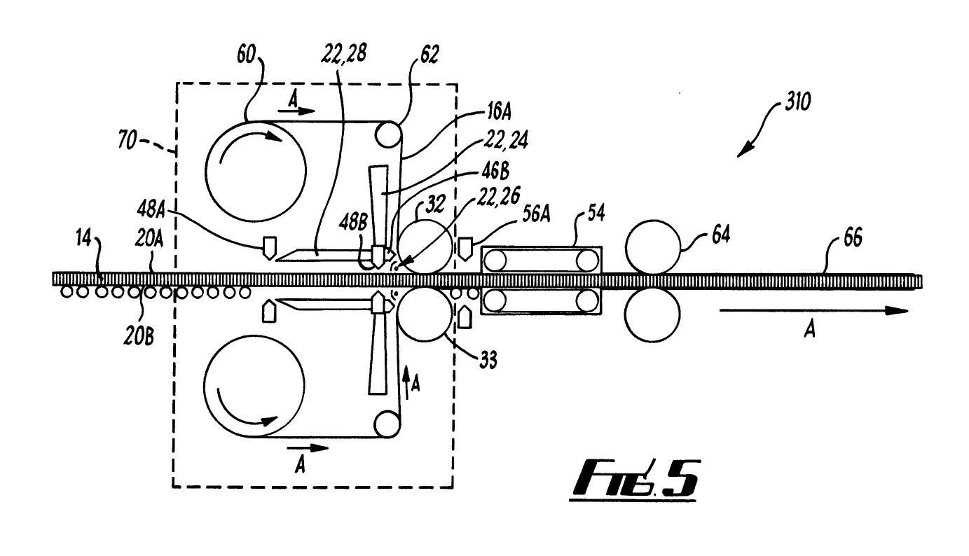

FIG. 5 is a schematic view of a fourth apparatus for bonding materials; and

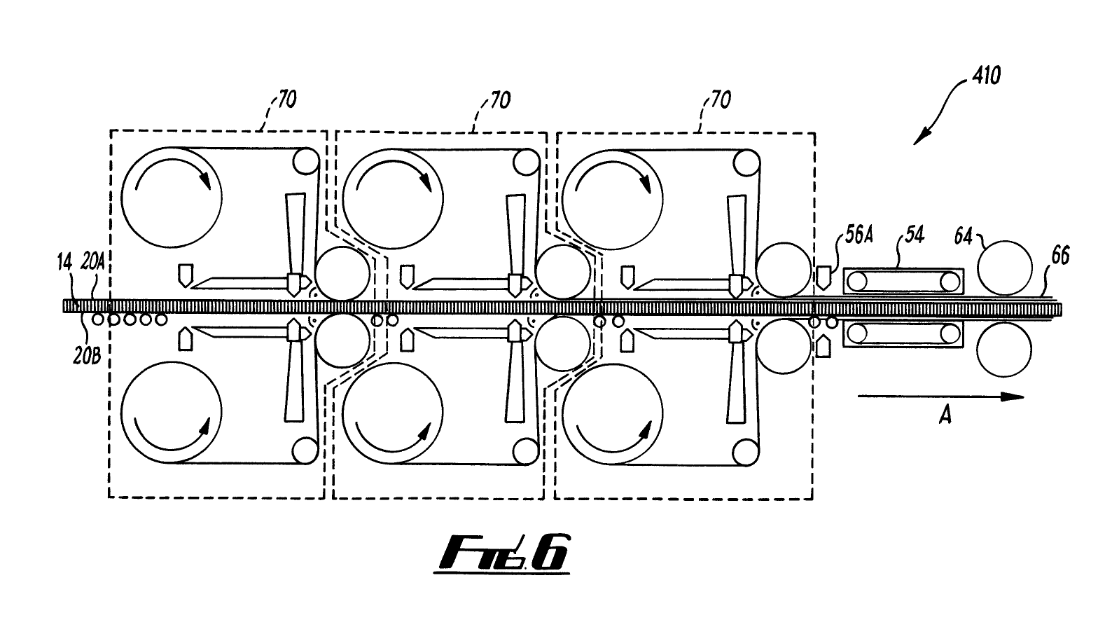

FIG. 6 is a schematic view of a fifth apparatus for bonding materials.

FIG. 1 shows, in a simplified schematic form, a bonding apparatus 10, which includes a heater arrangement 22, the heater arrangement 22 including a first heater 24, a second heater 26, and a third heater 28. The bonding apparatus 10 includes moving means 30 which include a pressure applicator including an upper pressure roller 32 and a lower pressure roller 33.

In one example, each of the heaters 24, 26, 28 is an infrared heater. As shown in FIG. 1, the second heater 26 includes an infrared element 40 which generates infra red heat and a reflector 42 which directs the infrared heat.

The apparatus 10 includes a support 29 to which the first, second and third heaters 24, 26, 28 are mounted. The support 29 is movable towards and away from the upper and lower pressure rollers 32, 33, as indicated by double headed arrow E in FIG. 1. The apparatus 10 includes an actuator 58 for actuating the said movement.

In use, a first thermoplastic material 12 is fed around the upper pressure roller 32 and on to a second thermoplastic material 24. The moving means, of which the upper and lower pressure rollers 32, 33 form only a part, move the first and second materials 22, 24 as shown by arrows A in FIG. 1.

The first material 12 passes adjacent to the first heater 24, which heats a bonding surface 16 of the first material 12, and the second material 14 passes adjacent to the third heater 28, which heats a bonding surface 20 of the second material 24, as shown by arrows B in FIG. 1.

The heated bonding surface 16 of the first material 12 meets the heated bonding surface 20 of the second material 14 at a bonding position 34 between the upper and lower pressure rollers 32, 33. The second heater 26 is arranged to direct the infrared heat to the first and second bonding surfaces 16, 20 at and/or just before the bonding position 34 to provide a “pulse” of heat at the bonding position 34, as shown by arrow C in FIG. 1.

The first and third heaters 24, 28 are arranged to raise the temperature of the bonding surfaces 16, 20 to a temperature just below the melting temperature of the first and second thermoplastic materials 12, 14. The heat pulse provided by the second heater 26 raises the temperature of the bonding surfaces 16, 20 above the melting temperatures of the first and second thermoplastic materials 12, 14, so that as the first and second materials 12, 14 pass between the pressure rollers 32, 33, the first and second materials 12, 14 are forced together and the melted surfaces 16, 20 fuse to form a weld layer 36, which is then cooled. As the weld layer 36 cools, it solidifies, bonding the first and second materials 12, 14 together form a composite bonded material 66.

The heating provided by the first and third heaters 24, 28 and the heat pulse provided by the second heater 26 is carefully controlled, so that at the bonding position 34 the temperature of the first material 12 and of the second material 14 decreases through each of the respective materials, so that for each material, at an opposite non bonding surface 18, 38 respectively the temperature of the respective material is lower than the melting point of that material. The temperature of the upper and lower pressure rollers 32, 33 could also be controlled, for example by internal heating elements.

The careful control of the heating provides several advantages. The first material is a relatively thin, sheet-like material. The application of too much heat can cause sticking of the first material 12 to the upper pressure roller 32, or require the use of process lubricants or non stick surfaces to reduce the risk of the first material 12 sticking to the upper pressure roller 32. As the first material 12 is a relatively thin material, overheating can lead to tearing of the first material 12, or variations in thickness or appearance of the first material 12, which is unsightly. The second material is a relatively thick material, but could be in the form of a honeycomb, with honeycomb walls defining vertical passages, and thus the second material bonding surface which comprises the ends of the honeycomb walls could be relatively small. Overheating of this relatively small surface could cause thinning and product unevenness, and reduce the effective pressure applied between the pressure rollers 32, 33.

In contrast, the application of sufficient heat which for the first material 12 melts the bonding surface 16 of the first material 12 but not the opposite non bonding surface 18, reduces power requirements, increasing efficiency and reducing cost. Product appearance is improved and processing efficiency is increased.

In one example, the first material 12 and the second material 14 are polypropylene. In the composite material 66, the first material 12 forms a skin to the second material 14 which forms a core. The first and second materials 12, 14 could themselves be composites. For example, the first material 12 could comprise plastics or glass fibres within a plastics matrix.

In another example, the bonding apparatus 10 could form a composite material 66 by melting only one of the bonding surfaces 16, 20.

FIG. 2 shows the bonding apparatus 10 in more detail. In the example shown in FIG. 2, the bonding apparatus 10 includes control means which include a controller 44 and temperature sensing means including a plurality of temperature sensors 46, 48, 56, the temperature sensors 46, 48, 56 being in signal communication with the controller 44.

The apparatus 10 includes cooling means in the form of a cooler 54, which cools the composite bonded material 66.

The temperature sensing means include a pair of spaced first temperature sensors 46A, 46B which sense the temperature of the bonding surface 16 of the first material 12 before and after the first heater 24 respectively.

The temperature sensing means include a pair of spaced second temperature sensors 48A, 48B which sense the temperature of the bonding surface 20 of the second material 14 before and after the third heater 28 respectively.

The temperature sensing means include third temperature sensors 56A, 56B which sense the temperature of the opposite, non bonding surface 18 of the first material 12 in the bonded condition after the upper roller 32, one of the third temperature sensors 56A being positioned after the upper roller 32 and before the cooler 54 and the other of the third temperature sensors 56b being positioned after the cooler 54.

Each of the first, second and third temperature sensors 46A, 46B, 48A, 48B, 56A, 56B provides an input signal 50 to the controller 44. In response to the input signals 50, the controller 44 provides output signals as indicated by arrows 52 to the first heater 24, the second heater 26, the third heater 28, the moving means 30, and the cooler 54, adjusting the speed of movement of the moving means 30 and hence the first and second materials 12, 14 past the said heaters 24, 26, 28 and cooler 54, and adjusting the heat output of the heaters 24, 26, 28 and the amount of cooling provided by the cooler 54.

The controller 44 could also provide an output signal to the actuator 58, to adjust the spacing of the heater arrangement 22 from the first and second bonding surfaces 16, 20, thus varying the heating effect of the heater arrangement 22.

In one example, the temperature sensors 46, 48, 56 are infra red sensors, which sense temperature via an infra red beam indicated by arrows D in FIG. 2. Such temperature sensors have the advantage that contact with a surface is not required to detect the temperature of the surface.

Polypropylene softens at 150-160° C., and melts at 180-190° C. In one example, the temperature of the bonding surface 16 of the first material 12 after the first heater 24 as measured by the first temperature sensor 46b could be in the region of 170-180° C., and similarly the temperature of the bonding surface 20 of the second material 14 after the third heater 28 as measured by the second temperature sensor 48b could be 170-180° C. The temperature of the bonding surfaces 16, 20 of the first and second materials 12, 14 at the bonding position 34 could be at least 200° C. and optimally 210° C. In contrast, it is desirable that the temperature of the opposite, non bonding surface 18 of the first material 12 remains as low as possible, and in one example this could be maintained at less than 150° C.

As described above, the first material 12 could be relatively thin, and could form a skin on the second material 14, which could form a core, and could be in the form of a honeycomb. The thickness of the first material 12 could be 1 mm or less, and optimally could be approximately 0.7 mm. The thickness of the second material 14 could be in the region of 15 to 100 mm.

The relationship between the speed of movement of the first and second materials 12, 14 and the heat output of the first, second and third heaters 24, 26 and 28 is important. If the first and second materials 12, 14 are moving too slowly, or the amount of heat applied by the first heater 24 is too high relative to the speed of the first material 12, then heat will penetrate through the first material 12 to the non bonding surface 18, leading to the deleterious effects described above. Conversely, if the speed of the first material 12 is too high, or the heat applied by the first heater 24 is too low relative to the speed of the first material 12, then the bonding surface 18 of the first material 12 may be incompletely or insufficiently melted for a good bond to be made.

Optimally the control means is arranged to provide automatic feedback control of the temperature of the bonding and non bonding surfaces 16, 18 of the first material 12 and of the bonding surface 20 of the second material 14.

FIG. 3 shows another apparatus 110 for bonding materials, many features of which are similar to those previously described in relation to the embodiments shown in FIGS. 1 and 2. Where features are the same, the same reference numerals have been used and these features will not be described again for the sake of brevity.

The arrangement of the apparatus 110 shown in FIG. 3 is similar to that shown in FIG. 2, except that in the apparatus 110, an upper first material 12A and a lower first material 12B are applied to opposite sides of the second core material 14 to produce a composite bonded material 66 comprising the second core material 14, sandwiched between a pair of first skin materials 12. The apparatus 110 includes feed means including, for each of the first skin materials 12A, 12B, a feed roller 60 from which the first material 12A, 12B is fed via a pair of tension rollers 62 to the upper and lower pressure rollers 32, 33. The apparatus 110 includes a heater arrangement 22 including a first heater 24, a second heater 26 and a third heater 28 for heating each of the upper and lower bonding surfaces 20A, 20B of the second material 14 and the bonding surfaces 16A, 16B of the first materials 12A, 12B respectively.

In the example shown in FIG. 3, the apparatus 110 includes control means, the control means including temperature sensing means, the temperature sensing means including temperature sensors 46B sensing the temperatures of the bonding surfaces 16A, 16B of the first materials 12A, 12B after the first heaters 24, temperature sensors 48B sensing the temperatures of the bonding surfaces 20 of the second material 14 after the third heaters 28, and temperature sensors 56A sensing the temperatures of the non bonding surfaces 18 of each of the first materials 12A, 12B after the pressure rollers 32, 33.

The apparatus 110 includes cooling means in the form of a cooler 54, which could be in the form of a double steel belt, the steel belt being cooled by refrigeration means to remove heat from the bonded material 66 in a uniform way and prevent any warping or other unwanted deformation of the bonded material 66.

The apparatus 110 includes moving means, which include traction rollers 64 which “pull” the material through the apparatus 110. As described previously, the moving means also include the pressure rollers 32, 33, which could be powered.

The double skinned bonded material 66 formed by the apparatus shown in FIG. 3 could be cut into lengths to form rigid planar sheets or panels, which could be used in the lining of vehicle bodies and for building and construction applications.

If it is wished to increase the strength of the finished panel, the bonded material 66 can be substituted for the second material 14 and fed through the apparatus 110 again, and an extra layer of first material 12 applied, providing a thicker skin and thus increasing the strength of the finished panel.

FIG. 4 shows a third bonding apparatus 210 for bonding materials, the features of which are similar to those previously described. Where features are the same or similar, the same reference numerals have been used, and these features will not be described again for the sake of brevity.

In the third bonding apparatus 210, first materials 12A, 12B are bonded to a second material 14 at first pressure rollers 32A, 33A and subsequently another layer of each of first materials 12C, 12D are applied to build up the thickness of the skins of the finished product for extra strength. Each of the first materials 12A, 12B, 12C, 12D is heated by first heaters 24. Second heaters 26 each apply a pulse of heat at or adjacent to the bonding positions 34 at the point where each of the first materials 12A, 12B, 12C, 12D meet with the second material 14, or in the case of the second stage application the non bonding surface 18 of the first material 12. As previously described, the temperature of the first and second materials 12A, 12B, 12C, 12D, 14 is carefully controlled to ensure that melting only occurs of the bonding surfaces 16, 20.

FIG. 5 shows a fourth bonding apparatus 310 for bonding materials, the features of which are similar to those previously described. Where features are the same or similar, the same reference numerals have been used, and these features will not be described again for the sake of brevity.

The fourth bonding apparatus 310 is similar to the bonding apparatus shown in FIG. 3, except that the feed rollers 60 are located forward and outward of the third heaters 28, resulting, in a much more compact and space efficient arrangement. In the example shown in FIG. 5, only one tension roller 62 is required between each feed roller 60 and each pressure roller 32, 33. The heater arrangements 22, the temperature sensors 46, 48, the feed rollers 60, the tension rollers 62 and the pressure rollers 32, 33 together comprise a module 70. Thus the module 70 bonds a skin of the first material 12 to the second material 14 or a pair of opposing skins of the first material 12 to the second material 14.

FIG. 6 shows a fifth bonding apparatus 410 for bonding materials, the features of which are similar to those previously described. Where features are the same or similar, the same reference numerals have been used, and these features will not be described again for the sake of brevity.

The fifth bonding apparatus 410 is similar to the fourth bonding apparatus 310 but includes a plurality of modules 70. Each successive module 70 bonds a further pair of skins of the first material 12 to the second material 14.

Various modifications could be made without departing from the scope of the invention. The first and second materials could be any suitable thermoplastic materials. The first and second materials could be different thermoplastic materials, and could be of any suitable size, shape, thickness and type of construction. The heater arrangement could comprise any suitable number of heaters, of any suitable power, arranged in any suitable position. The control means could include any suitable number of temperature sensors. The moving means and the pressure applicator could be of any suitable type. The cooling means could be of any suitable type. The traction means could be of any suitable type. The feed means could be of any suitable type.

In one example, a similar apparatus could be used to apply a third thermoplastic material in the form of an edge closing material to, for example, the bonded material 66 previously described. A heater arrangement could be arranged to heat a bonding surface of the third material to melt the bonding surface, and moving means could be arranged to move the third material and the bonded material to a bonded condition. Thus the third material could be bonded to an edge or edges of the bonded material.

There is thus provided bonding apparatus for bonding materials, in which careful control of the application of heat permits control of the degree of melting of the first and second materials, providing improved product quality and process efficiency.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A bonding apparatus for bonding a thermoplastic first material to a second material, the apparatus including a heater arrangement for heating a bonding surface of the first material to melt the bonding surface, and moving means for moving the first and second materials together to a bonded condition.

2. Apparatus according to claim 1, in which the heater arrangement includes a first heater which is arranged to heat the bonding surface of the first material.

3. Apparatus according to claim 2, in which the first heater is arranged to heat the bonding surface of the first material to a temperature which is below the melting point of the first material.

4. Apparatus according to claim 1, in which the heater arrangement includes a second heater, which is arranged to heat the bonding surface of the first material.

5. Apparatus according to claim 4, in which the second heater heats the bonding surface of the first material to a temperature that is above the melting temperature of the first material.

6. Apparatus according to claim 1, in which the second material is a thermoplastic material.

7. Apparatus according to claim 1, in which the second material includes a bonding surface, and in the bonded condition, the bonding surface of the first material is bonded to the bonding surface of the second material.

8. Apparatus according to claim 7, in which the heater arrangement is arranged to melt the bonding surface of the second material.

9. Apparatus according to claims 7, in which the heater arrangement includes a third heater, which is arranged to heat the second material bonding surface.

10. Apparatus according to claim 9, in which the third heater is arranged to heat the bonding surface of the second material to a temperature which is below the melting point of the second material.

11. Apparatus according to claim 8, in which the heater arrangement includes a second heater, which is arranged to heat the bonding surface of the first material, and the second heater heats the bonding surface of the second material to a temperature that is above the melting temperature of the second material.

12. Apparatus according to claim 7, in which the moving means move the first and second materials to a bonding position, in which the first material bonding surface and the second material bonding surface come into contact.

13. Apparatus according to claim 12, in which the heater arrangement includes a second heater, which is arranged to heat the bonding surface of the first material, the second heater heats the bonding surface of the second material to a temperature that is above the melting temperature of the second material, and the second heater is arranged to heat the bonding surface of the first material and/or the second material at or adjacent to the bonding position.

14. Apparatus according to claim 12, in which the apparatus is arranged so that at the bonding position, the temperature of the first material decreases through the material.

15. Apparatus according to claim 14, in which the apparatus is arranged so that at the bonding position, the temperature of the first material decreases through the material so that at an opposite first material non-bonding surface the temperature of the first material is lower than the melting point of the first material.

16. Apparatus according to claim 11, in which the apparatus is arranged so that at the bonding position, the temperature of the second material decreases at least initially from the second material bonding surface through the second material to a temperature which is lower than the melting point of the second material.

17. Apparatus according to claim 1, in which the moving means include a pressure applicator, which is arranged to force the first and second materials together to the bonded condition.

18. Apparatus according to claim 1, in which the apparatus includes control means, which include a temperature sensor and a controller, the control means being arranged so that the sensor provides a signal to the controller.

19. Apparatus according to claim 18, in which the controller controls the heat output of the heater arrangement in response to the signal.

20. Apparatus according to claim 18, in which the controller controls the spacing of the or each heater from the or each respective bonding surface in response to the signal.

21. Apparatus according to any of claim 18, in which the controller controls the speed of the movement of the moving means in response to the signal.

22. Apparatus according to claim 1, in which the first material is relatively thin, and the second material is relatively thick.

23. Apparatus according to claim 1, in which the first material is in the form of a skin and the second material is in the form of a core.

24. Apparatus according to claim 1, in which in the bonded condition the first and second materials form a composite material, which is shaped to form a planar, sheet-like panel.

25. Apparatus according to claim 1, in which the bonding apparatus includes another heater arrangement for heating a bonding surface of another first material to melt the bonding surface, and another moving means for moving the other first and the second material together to a bonded condition, the other first material being bonded to an opposite side of the second material.

26. Apparatus according to claim 1, in which the bonding apparatus includes a further heater arrangement for heating a bonding surface of a further first material to melt the bonding surface, and a further moving means for moving the further first and the second materials together to a bonded condition, the further first material being bonded to the first material or the other first material which is already bonded to the second material.

27. Apparatus according to claim 1, in which the bonding apparatus includes a module, which includes the heater arrangement and the moving means or a pair of opposing heater arrangements and moving means, and in use, the module bonds a skin of the first material to the second material or a pair of opposing skins of the first material to the second material.

28. Apparatus according to claim 27, in which the bonding apparatus includes a plurality of modules, in which each successive module bonds a further skin or pair of skins of the first material to the second material.

29. Apparatus according to claim 1, in which the heater arrangement is arranged to heat a third material, which is a thermoplastic material, and is arranged to heat a bonding surface of the third material to melt the bonding surface.

30. Apparatus according to claim 29, in which the moving means are arranged to move the third material and the first and/or second materials together to a bonded condition.

31. Apparatus according to claim 30, in which in the bonded condition the third material is bonded to an edge of the bonded first and second materials.

32. A process for bonding a thermoplastic first material to a second material, the process including the steps of applying heat to a surface of the first material to melt the surface and moving the first material and the second material together to a bonded condition.

33. A process according to claim 32, in which the process includes the step of providing a bonding apparatus for bonding the first thermoplastic material to the second material.

34. A process according to claim 33, in which the bonding apparatus includes a heater arrangement for heating a bonding surface of the first material to melt the bonding surface, and moving means for moving the first and second materials together to a bonded condition

35. A bonded product, the bonded product comprising a thermoplastic first material bonded to a second material, the product produced by bonding apparatus as defined in claim 1.

36-39. (canceled)
